(19) United States
(12) Patent Application Publication
(10) Pub. No.: US 2025/0340484 A1
(43) Pub. Date: Nov. 6, 2025

(54) TEQUILA STILLAGE MORTAR AND CONCRETE

(71) Applicant: University of Kentucky Research Foundation, Lexington, KY (US)

(72) Inventors: Robert Benjamin Jewell, Lexington, KY (US); Anne Elizabeth Oberlink, Lexington, KY (US); Rodney Andrews, Lexington, KY (US); David Eaton, Lexington, KY (US)

(21) Appl. No.: 19/267,120

(22) Filed: Jul. 11, 2025

Related U.S. Application Data
(63) Continuation-in-part of application No. 18/282,788, filed on Sep. 19, 2023.
(60) Provisional application No. 63/163,294, filed on Mar. 19, 2021.
(60) Provisional application No. 63/284,496, filed on Nov. 30, 2021.

(51) Int. Cl. C04B 18/30; C04B 28/04

(52) U.S. Cl. CPC C04B 18/30; C04B 28/04

(57) ABSTRACT

A mortar mix and a concrete mix incorporate a tequila stillage admixture that improves the workability of fresh concrete and advantageously modifies the properties of the hardened concrete.

### RELATED APPLICATION

This application is a Continuation-in-Part of U.S. patent application Ser. No. 18/282,788, filed Sep. 19, 2023, which claims priority to International App. No. PCT/US2022/021112, filed Mar. 21, 2022, which claims the benefit of U.S. Provisional Patent Application Ser. No. 63/163,294, filed on Mar. 19, 2021, and U.S. Provisional Patent Application Ser. No. 63/284,496, filed on Nov. 30, 2021, all of which are hereby incorporated by reference in their entirety.

### TECHNICAL FIELD

This document relates generally to the use of tequila stillage liquid as an admixture in mortar and concrete in order to improve the workability/flow of fresh concrete and to modify the properties of the hardened mortar or concrete.

### BACKGROUND

Tequila stillage is the liquid waste that remains after tequila distillation where large amounts of water are mixed with crushed agave. The tequila distillery industry produces a very significant amount of tequila stillage each year thereby creating a waste disposal concern.

As set forth in this document, it has now been discovered that the tequila stillage liquid may be used as a “green” admixture in mortar and concrete. The substitution of this stillage liquid for some or all of the water normally used in mortar and concrete allows for a reduction in the total volume of water used in the mortar or concrete which, in turn, imparts a number of benefits and advantages including, but not necessarily limited to increased strength performance and improved concrete rheology. Further, this new use of the tequila stillage liquid also eliminates the need to dispose of what would otherwise be a waste product of the tequila distillery industry.

### SUMMARY

In accordance with the purposes and benefits described herein, a new and improved mortar mix is provided. That mortar mix comprises, consists of or consists essentially of: cement, sand, water and a tequila stillage liquid.

Preferably, the tequila stillage liquid is used as-received from the tequila distiller and no further processing is required. In at least one possible embodiment, the tequila stillage liquid has been subjected to a hydrothermal carbonization process prior to use in the mortar mix.

In accordance with yet another aspect, the mortar mix may include: (a) about 23.6-24.8 weight percent cement, (b) about 65.0-68.3 weight percent sand, (c) about 6.6-9.1 weight percent water and (d) about 0.3 to about 2.3 weight percent tequila stillage liquid. In some embodiments, all of the water is replaced by the tequila stillage liquid.

In one or more of the many possible embodiments of the mortar mix, the ratio of the volume of water to the volume of tequila stillage liquid is between about 4:1 and about 19:1.

In accordance with yet another aspect, a new and improved concrete mix, comprises: cement, sand, aggregate, water and a tequila stillage liquid. Preferably, the tequila stillage liquid is used as-received from the tequila distiller without any processing. In at least one possible embodiment, the stillage liquid has been subjected to a hydrothermal carbonization process prior to use in the concrete mix.

The concrete mix may include: (a) about 13.84-19.02 weight percent cement, (b) about 32.57-37.05 weight percent sand, (c) about 39.28-44.38 weight percent aggregate, (d) about 6.71-4.09 weight percent water and (e) about 2.41-0.34 weight percent tequila stillage liquid. In some embodiments, all of the water is replaced with tequila stillage liquid.

In one or more of the many possible embodiments of the concrete mix, the ratio of the volume of water to the volume of tequila stillage liquid is between about 3.3:1 and about 15.9:1.

A method is also provided for preparing a tequila stillage admixture for mortar or concrete. That method comprises the step of filtering solids from a tequila stillage liquid to provide the tequila stillage admixture.

In another aspect, a method is provided for preparing a tequila stillage admixture for mortar or concrete. That method comprises the step of subjecting a tequila stillage liquid to hydrothermal carbonization processing to provide the tequila stillage admixture.

A new method of preparing a tequila stillage admixture for mortar or concrete, comprises subjecting a tequila stillage liquid to hydrothermal carbonization processing to provide the tequila stillage admixture. This may include subjecting the tequila stillage liquid to a temperature of about 250° C. and a pressure of about 1.379 N/mm² during hydrothermal carbonization processing.

In the following description, there are shown and described several preferred embodiments of the mortar mix, the concrete mix and the methods related thereto. As it should be realized, the mortar mix, the concrete mix and the methods are capable of other, different embodiments and their several details are capable of modification in various, obvious aspects all without departing from the mortar mix, the concrete mix and the methods as set forth and described in the following claims. Accordingly, the descriptions should be regarded as illustrative in nature and not as restrictive.

### DETAILED DESCRIPTION

A mortar mix may be generally described as a mixture of cement, sand, water and a tequila stillage liquid. The cement may comprise Type-I, or Type-IL Portland cement or substantially any other cement known in the art to be useful in mortar. The tequila stillage liquid may be the liquid waste that remains after tequila distillation used as-received from the distiller. Such stillage is readily available from tequila distilleries and is often referred to as tequila stillage liquid.

In some embodiments, the tequila stillage liquid may be a processed tequila stillage liquid. Processed tequila stillage liquids include, but are not necessarily limited to, filtered tequila stillage liquid without solids and tequila stillage liquid that has been subjected to a hydrothermal carbonization process prior to use in the mortar mix.

The mortar mix may include about 23.6-24.8 weight percent cement, about 65.0-68.3 weight percent sand, about 6.6-9.1 weight percent water and about 0.3-2.3 weight percent tequila stillage liquid. The ratio of the volume of water to the volume of tequila stillage liquid is most commonly between about 4:1 to about 19:1. In some embodiments, the ratio of the volume of water to the volume of tequila stillage is between 4:1 to 15:1, or between 6:1 to 15:1, or between 8:1 to 15:1 or between 10:1 to 13:1. However, it should be appreciated that in some embodiments of the mortar mix for some applications, as much as all of the water may be replaced by tequila stillage liquid.

A concrete mix may be generally described as a mixture of cement, sand, aggregate, water and a tequila stillage liquid. The cement may comprise Type-I Portland cement or substantially any other cement known in the art to be useful in mortar. The aggregate may comprise gravel of a type and size known in the art to be useful in concrete. The tequila stillage liquid may be the liquid waste that remains after tequila distillation: preferably used as-is or as-received from the tequila distiller to avoid any processing time and costs. Such stillage is readily available from tequila distilleries and is often referred to as tequila stillage liquid.

As with the mortar mix described above, the tequila stillage liquid may be a processed tequila stillage liquid. Processed tequila stillage liquids include, but are not necessarily limited to, filtered tequila stillage liquid without solids and tequila stillage liquid that has been subjected to a hydrothermal carbonization process prior to use in the concrete mix.

The concrete mix may include about 13.84-19.02 weight percent cement, about 32.57-37.05 weight percent sand, about 39.28-44.38 weight percent aggregate, about 4.09-6.71 weight percent water and about 0.34-2.41 weight percent tequila stillage liquid. The ratio of the volume of water to the volume of tequila stillage liquid is most commonly between about 3.3:1 to about 15.9:1. In some embodiments, the ratio of the volume of water to the volume of tequila stillage is between 5:1 to 13:1, or between 6:1 to 12:1, or between 7:1 to 11:1 or between 8:1 to 10:1. However, it should be appreciated that in some embodiments of the concrete mix for some applications, as much as all of the water may be replaced by tequila stillage liquid.

Advantageously, the mortar mix and concrete mix including tequila stillage liquid are characterized by a number of benefits and advantages. Significantly, less water is required to provide the desired flow and workability to the mortar and the cement. The lower water/cement ratio imparts increased strength performance and improved concrete rheology.

Thus, it should be appreciated that a method of improving at least one performance characteristic of mortar includes the step of adding a tequila stillage liquid to the mortar as a substitute for at least some of the water in the mortar. Similarly, a method of improving at least one performance characteristic of concrete, includes the step of adding a tequila stillage liquid to the concrete as a substitute for at least some of the water in the concrete.

Related to the above is a method of preparing a tequila stillage admixture for mortar or concrete, including the step of filtering solids from a tequila stillage liquid to provide the tequila stillage admixture. Also provided is a method of preparing a tequila stillage admixture for mortar or concrete that includes the step of subjecting a tequila stillage liquid to hydrothermal carbonization processing to provide the tequila stillage admixture.

In an alternative embodiment, a new method of preparing a tequila stillage admixture for mortar or concrete includes the step of subjecting a tequila stillage liquid to hydrothermal carbonization processing to provide the tequila stillage admixture. The tequila stillage liquid may be subjected to a temperature of about 250° C. and a pressure of about 1.379 N/mm² during the hydrothermal carbonization processing.

### Experimental

Below represents a compressive strength data comparison of a mortar prepared without stillage, one prepared with bourbon stillage (not centrifuged to compare the benefit of not having to centrifuge the tequila stillage), and one mortar sample prepared with the as-received tequila stillage. Noting 10% of the total mixing water was replaced with stillage for both the bourbon and tequila mortar samples.

| Sample ID | Day 1 | Day 7 | Day 28 |
|---|---|---|---|
| Control (Type-I Portland cement) no stillage | 10.9 MPa | 27.8 MPa | 42.9 MPa |
| 10%/90% Bourbon Stillage Liquid to DI Water | 6.6 MPa | 32.0 MPa | 37.3 MPa |
| 10%/90% Tequila Stillage Liquid to DI Water | 11.8 MPa | 36.5 MPa. | 43.2 MPa |

The above comparative data demonstrates several of the benefits and advantages of using tequila stillage instead of bourbon stillage as a mortar admixture. When compared to a control with no stillage, the bourbon stillage admixture decreases the compressive strength of the mortar on Day 1 by about 40%, increases the compressive strength of the mortar on Day 7 by about 15% and decreases the compressive strength of the mortar on Day 28 by about 13%. In stark contrast, when compared to the control with no stillage, the tequila stillage increases the compressive strength of the mortar on Days 1, 7 and 28 by about 8%, about 31% and about 0.7% respectively. In comparison to the bourbon stillage, the tequila stillage provides increases in compressive strength of the mortar on Days 1, 7 and 28 by about 79%, about 14% and about 16% respectively. Thus, the tequila stillage admixture outperforms both the control and the bourbon stillage admixture at all data points of this comparison.

Summarizing, numerous benefits and advantages are provided by using tequila stillage as an admixture in mortar and concrete to modify the fresh properties thereof, including flow, and the hardened properties thereof, including compressive strength. The use of tequila stillage in place of bourbon stillage also provides a number of benefits, including, but not necessarily limited to:
No solids removal step required to utilize as-received tequila stillage from the distillery.
Tequila stillage has an inherent ability to resist mold growth. Therefore, TEQUILA STILLAGE CONCRETE tequila stillage does not require refrigeration or additional chemicals to inhibit mold growth. Bourbon stillage molds readily and must be refrigerated. The ability for tequila stillage to resist mold growth is highly beneficial in improving the shelf-life of the tequila stillage admixture. This trait of tequila stillage also reduces costs, as compared to bourbon stillage, by eliminating the need to add chemical mold stabilizers.
Additionally, tequila stillage does not require a final centrifugation step to clarify the stillage. This step is used with bourbon stillage to remove the solid fines caught in suspension.

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified.

Terms of approximation, such as the terms about, substantially, approximately, etc., as used herein, refers to ±10% of the stated numerical value.

Although the mortar mix, the concrete mix and the related methods of this disclosure have been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, fall within the spirit of, and are encompassed by, the broad scope of the appended claims.

What is claimed:

1. A mortar mix, comprising:
cement;
sand;
water; and
a tequila stillage liquid.

2. The mortar mix of claim 1, wherein the tequila stillage is used as-received from a tequila distiller.

3. The mortar mix of claim 1, wherein the tequila stillage liquid has been subjected to a hydrothermal carbonization process prior to use in the mortar mix.

4. The mortar mix of claim 2, wherein a ratio of a volume of the water to a volume of the tequila stillage liquid is between about 4 to 1 and about 19 to 1.

5. The mortar mix of claim 2, including:
about 23.6-24.8 weight percent cement;
about 65.0-68.3 weight percent sand;
about 6.6-9.1 weight percent water; and
about 0.3-2.3 weight percent tequila stillage liquid.

6. The mortar mix of claim 5, wherein a ratio of a volume of the water to a volume of the tequila stillage liquid is between about 4 to 1 and about 19 to 1.

7. A concrete mix, comprising:
cement;
sand;
aggregate;
water; and
a tequila stillage liquid.

8. The concrete mix of claim 7, wherein the tequila stillage is used as-received from a tequila distiller.

9. The concrete mix of claim 7, wherein the stillage liquid has been subjected to a hydrothermal carbonization process prior to use in the concrete mix.

10. The concrete mix of claim 7, wherein the tequila stillage liquid is a processed tequila stillage liquid.

11. The concrete mix of claim 7, wherein the tequila stillage liquid is a filtered tequila stillage liquid without solids.

12. The concrete mix of claim 8, wherein a ratio of a volume of the water to a volume of the tequila stillage liquid is between about 3.3 to 1 and about 15.9 to 1.

13. The concrete mix of claim 8, including:
about 13.84-19.02 weight percent cement;
about 32.57-37.05 weight percent sand;
about 39.28-44.38 weight percent aggregate;
about 4.09-6.71 weight percent water; and
about 0.34-2.41 weight percent tequila stillage liquid.

14. The concrete mix of claim 13, wherein a ratio of a volume of the water to a volume of the tequila stillage liquid is between about 3.3 to 1 and about 15.9 to 1.

15. The concrete mix of claim 8, wherein a ratio of a volume of the water to a volume of the stillage liquid is between about 3.3 to 1 and about 15.9 to 1.
